(19) United States
(12) Patent Application Publication
(10) Pub. No.: US 2026/0228621 A1
(43) Pub. Date: Aug. 6, 2026

(54) MODEL UNCERTAINTY QUANTIFICATION WITH DYNAMIC PARAMETERS

(71) Applicant: THE TORONTO-DOMINION BANK, TORONTO (CA)

(72) Inventors: Valentin Victor Villecroze, TORONTO (CA); Gabriel Loaiza Ganem, TORONTO (CA); Maksims Volkovs, TORONTO (CA)

(21) Appl. No.: 19/305,193

(22) Filed: Aug. 20, 2025

Related U.S. Application Data
(60) Provisional application No. 63/754,774, filed on Feb. 6, 2025.

(51) Int. Cl. G06N 20/00

(52) U.S. Cl. CPC G06N 20/00

(57) ABSTRACT

An uncertainty model is used to quantify uncertainty about model predictions using a model architecture including a layer with static parameters and a layer with dynamic parameters. The dynamic parameters are determined by sampling from a probability distribution and applying an invertible model, such as a normalizing flow. As such, the output of the invertible model generates a set of parameter values together for the dynamic model layer. Different samples of the probability distribution applied to the invertible model yield different sets of dynamic parameter values. By generating model outputs with different sets of dynamic model parameter values, the uncertainty of the trained model can be quantified and used to determine the extent to which model evaluation could vary for different trained parameter values.

### CROSS-REFERENCE TO RELATED APPLICATION

This application claims the benefit of U.S. Provisional Application No. 63/754,744, filed on Feb. 6, 2025, the contents of which is hereby incorporated by reference in its entirety.

### BACKGROUND

This disclosure relates generally to modeling uncertainty and more particularly to uncertainty quantification using models with dynamic parameters.

Uncertainty quantification (UQ) is a critical task in various settings using computer modeling and other applications of computer models. Uncertainty quantification may describe, e.g., the extent to which different trained models and/or parameters may effectively learn a data set, and how those different models evaluate a particular data sample. For example, when an ensemble of different models are trained on the same training data, each individual model may obtain different parameters. The trained models may differ due to different initialized model parameters, different training data batches, and so forth. Although the models may be “equivalently” trained on the same training data, the different learned parameters may yield different evaluations of new data samples. The uncertainty quantification may thus numerically describe the effect that these different parameters (or different trained models) may have on a new data sample. When the different models yield similar evaluations of a data sample, the evaluation of the data sample may be relatively invariant to the particular trained model used, suggesting the model evaluations may be more trustworthy and more “certain.” Similarly, when different trained models (trained on the same data set) yield relatively dissimilar evaluations for a data sample, the uncertainty is higher for the models applied to that data sample.

Though UQ may be evaluated with an ensemble of different models, this process may be relatively computationally expensive as it requires training each of the different models independently. While other model types, such as Bayesian Neural Networks, may permit uncertainty quantification by modeling individual parameters as a distribution, this approach typically describes individual parameters with respective probability distributions. However, because each parameter has a distribution, this approach neglects to account for the interrelationships between the parameters, such that each parameter may have a distribution that fails to account for how a change in one parameter affects another. As UQ can be used for various purposes, such as determining the certainty for evaluating a data sample or the data sample's fitness for applying an action based on automated model evaluation, there is a need to improve systems for uncertainty quantification.

### SUMMARY

Rather than training an ensemble of models individually, an uncertainty model architecture is used for uncertainty quantification that includes a dynamic model layer with parameters that may be determined based on probability distribution samples transformed by an invertible model, such as a normalizing flow. A particular instance of the trained uncertainty model may be generated by sampling from a known probability distribution and applying the invertible model to determine an instance of dynamic parameters for the dynamic model layer. Together, a distribution of the dynamic model parameters may be defined by the different values of the dynamic parameters that may be obtained from different samples of the probability distribution as transformed by the invertible model. In addition, because the invertible model ensures a 1:1 relationship between the probability distribution and the dynamic parameters, the distribution of dynamic parameters is prevented from collapsing to single values (e.g., for individual dynamic parameters). In addition, as the dynamic model parameters are generated together from the invertible model, interrelationships between the dynamic parameters may be effectively modeled in the distribution of dynamic model parameters. This is not possible, e.g., when individual parameters are modeled as Bayesian distributions (e.g., when individual parameters are modeled as having a mean value and a variance). The uncertainty model architecture may use a dynamic model layer for at least one layer of the model architecture and, in various embodiments, includes one or more static model layers.

To quantify uncertainty for a particular data sample, the uncertainty model may be applied to the data sample using different values of the dynamic model parameters sampled from the probability distribution and transformed by the invertible model. The data sample may then be evaluated by the static model layer and the different dynamic model parameters to obtain different model outcomes representing different instances of the computer model (i.e., at different points of the dynamic model parameters). The different model outputs may then be evaluated to determine an uncertainty quantification based on the model outputs. For example, the uncertainty quantification may be a variance of the model outcomes. The more significant the differences between the model outputs, the higher the resulting uncertainty in the outcomes according to the differing dynamic model parameters. The uncertainty quantification may then be used to modify actions applied to the data sample, for example to identify the data sample as in- or out-of-distribution relative to the training set or to prevent application of a model prediction when the uncertainty is above a threshold.

In some embodiments, the uncertainty model is trained by separately training the static parameters and the dynamic parameters. First, the architecture as a whole may be trained as static parameters, such that the dynamic model layer may be treated as a static layer, such that discrete parameter values are trained for the static model layer and for the dynamic model layer in an initial training step. This allows the training objective to be propagated to earlier static layers of the uncertainty model tractably. Then, the trained values of the static model layer may be fixed for learning the distribution of dynamic model parameters by training parameters of the invertible model. As the static layer(s) parameters are then fixed, particular training data samples may be processed by the static layers to generate representations used in training the dynamic parameter distribution without requiring any further propagation from the dynamic layers to the static layers during the second step.

### BRIEF DESCRIPTION OF THE DRAWINGS

FIG. 1 illustrates an example uncertainty modeling system, according to one or more embodiments.

FIG. 2 shows an example architecture for an uncertainty model, according to one or more embodiments.

FIG. 3 shows an example evaluation of uncertainty quantification with respect to a data sample using an uncertainty model according to one or more embodiments.

FIG. 4 is an example flowchart for applying an uncertainty model with dynamic model parameters for uncertainty quantification, according to one embodiment.

FIGS. 5A-B show an example data flow for training an uncertainty model, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

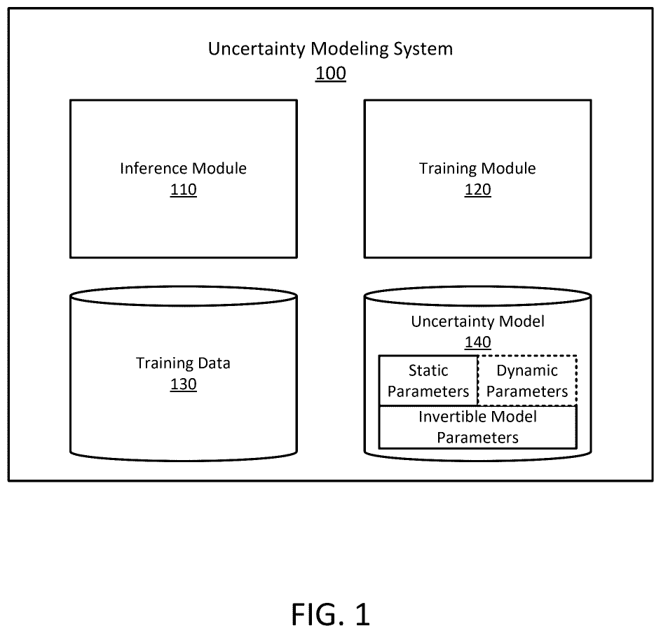

FIG. 1 illustrates an example uncertainty modeling system 100, according to one or more embodiments. The uncertainty modeling system 100 uses an uncertainty model 140 to quantify uncertainty of model predictions with respect to a data sample. This may also be termed “Uncertainty Quantification” (UQ), which evaluates the uncertainty of different trained model parameters to a data sample and may indicate the consistency with which trained computer models evaluate a given data sample. For various reasons, the same model architectures trained on the same training data (with the same training objective) may yield different optimized values for the model parameters. These different model parameters may then yield different evaluations of a new data sample input to the different models. Uncertainty Quantification may thus be used to represent the extent to which different trained model instances, although generally expected to individually have optimized parameters for the same training data, may evaluate different outcomes for a data sample.

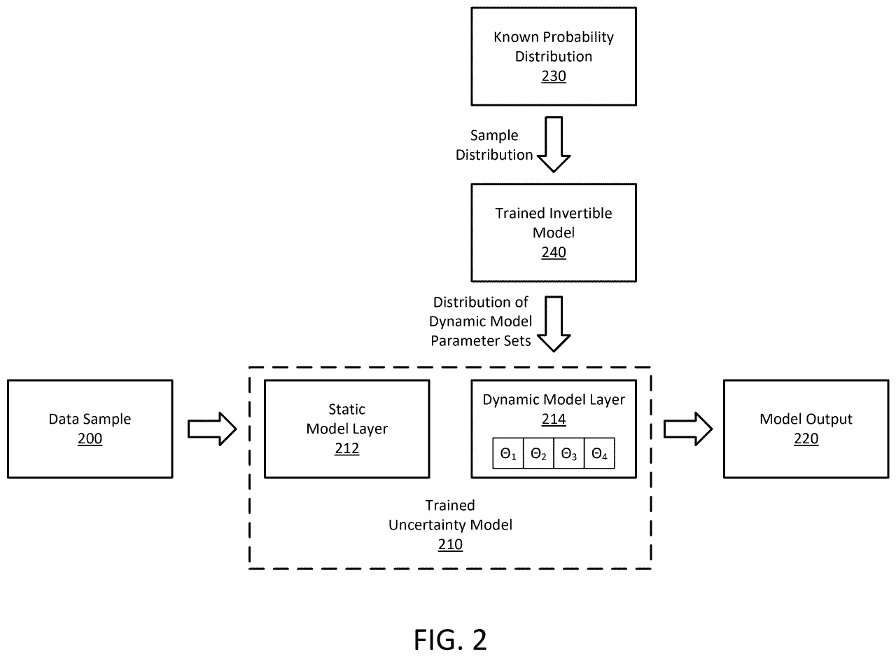

The uncertainty modeling system 100 generates uncertainty quantification for a data sample using an uncertainty model 140. Rather than use a plurality of separately trained models, the uncertainty model 140 learns to represent the different values of model parameters that may be learned from the training data 130 using one or more model layers that have dynamic parameters. Rather than learning discrete, fixed values for the dynamic parameters, the dynamic parameters are determined for particular applications of the uncertainty model by sampling from a probability distribution and processing the sample with a learned invertible function defined by a set of invertible model parameters. In addition to the dynamic parameters, the model architecture may include a set of static parameters that are fixed for different applications of the model. As the dynamic parameters may be determined for each application of the model, the data stored for the uncertainty model 140 may include the static parameters for the model and the parameters for the invertible model used to generate the dynamic parameters. Additional information about the structure of the uncertainty model 140 are discussed below with respect to FIG. 2.

Various aspects of the uncertainty model 140, including the particular type of inputs (e.g., individual data samples) used by the uncertainty model 140, vary in different embodiments. In various embodiments, the uncertainty model may receive data inputs, such as an image, video, text, tabular data, and other types of data that may be processed by the uncertainty model 140 to generate an output related to the data sample. In many cases, for example, the output from the uncertainty model may be a classification or other evaluation of the input data sample with respect to predicted membership of the data sample in a class. As discussed further below, parameters of the uncertainty model 140 may be trained based on a set of training data 130 having labels to be predicted as an output of the uncertainty model 140. The particular structure and parameters of the uncertainty model 140 may vary in different embodiments, and may include, for example, thousands or millions or more parameters for processing a data sample to an output of the model.

The architecture of the uncertainty model 140 may include various types of layers that process a layer input to a layer output, which is then used as an input for a subsequent layer. The particular layers in the uncertainty model vary in different embodiments, and may include, for example, convolutional layers, pooling layers, residual layers, skip layers, dropout layers, activation layers, linear layers, attention layers, sequencing layers, embedding layers, fully-connected layers, and so forth.

The uncertainty modeling system 100 includes an inference module 110 and a training module 120 for using and training the uncertainty model 140. The inference module 110 may receive or otherwise identify a data sample for application of the uncertainty model 140, and particularly for determination of a quantified uncertainty for the data sample with respect to the uncertainty model 140. The training module 120 trains parameters of the uncertainty model 140 based on one or more training data samples in the training data 130. Additional details regarding application of the uncertainty model 140 and its training are further discussed below.

Although shown in FIG. 1 as a single uncertainty modeling system 100, these components may be disposed across various individual computing systems. For example, in some embodiments the training module 120 may train parameters of the uncertainty model 140 across one or more computing systems. After training, the uncertainty model 140 may be made accessible or distributed to one or more computing systems for processing requests for particular data samples to be evaluated with respect to the uncertainty model 140. These computing systems may then process requests in parallel for applying the uncertainty model 140 to particular data samples.

The uncertainty modeling system 100 may be incorporated in or communicate with additional systems or devices. For example, the uncertainty modeling system 100 may be used to determine whether a new data sample is in- or out-of-distribution with respect to the training data 130. The uncertainty model 140 and inference module 110 may be incorporated into a system that receives new data samples and uses the determination of in- or out-of-distribution to determine whether to apply additional computer models or automated decision making to a data sample. For example, when a data sample is in-distribution with respect to the training data, this may indicate that additional models that are based on the training data may be expected to perform with higher-confidence with respect to the data sample. Meanwhile, when a data sample is out-of-distribution, model predictions may be less reliable as the data sample is relatively different from the data that may have trained the relevant models, such that model predictions may be relatively untrustworthy. In various environments, data samples evaluated as out-of-distribution may thus be prevented from application of automated model evaluations, provided for escalate review, or processed by non-automated processes.

FIG. 2 shows an example architecture for an uncertainty model, according to one or more embodiments. The architecture shown in FIG. 2 illustrates an uncertainty model after training, such that the trained uncertainty model 210 includes model parameters for effectively generating a model output 220 based on a received data sample 200. The trained uncertainty model 210 includes a plurality of model layers that process the data sample 200 to the model output 220. Particularly, the trained uncertainty model 210 includes a static model layer 212 and a dynamic model layer 214. Although one of each of these layer types is shown in FIG. 2, in varying embodiments additional layers may also be included in various embodiments.

The static model layer 212 is a model layer having parameters that are fixed, such that the parameters of the static model layer 212 have set values (e.g., after training, they are held constant for each application of the uncertainty model). In contrast to the static model layer 212, the dynamic model layer 214 has parameters, shown here as dynamic parameters Θ₁₋₄, that may be specified “dynamically” for different applications of the trained uncertainty model 210. A particular set of parameters for the dynamic model layer 214 may be referred to as a “dynamic model parameter set.” For example, one dynamic model parameter set for dynamic parameters Θ₁₋₄ may have values of {0.4, 0.5, 0.5, 0.2} for the respective dynamic parameters. To obtain a dynamic model parameter set, a sample is taken from a known probability distribution 230 (e.g., a Gaussian) and applied to a trained invertible model 240 that transforms the sample from the probability distribution to an output as the dynamic model parameter set (for the set of parameters corresponding to the particular sample of the known probability distribution 230). The trained invertible model 240 learns parameters for transforming from the known probability distribution to a distribution of dynamic model parameters sets. As such, the overall dynamic model layer 214 may be defined by the overall distribution of dynamic model parameter sets output by the invertible model, rather than a specific dynamic parameter set. As discussed further below, the different dynamic model parameter sets used in the dynamic model layer 214 represent different values that “could be” learned for the dynamic model layer 214, such that application of different dynamic model parameter sets can be used to obtain different model outputs 220 for uncertainty quantification.

The known probability distribution 230 may have any suitable dimensionality, and may include, for example, a number of dimensions equal to the number of parameters in the dynamic model layer 214. In some instances, the number of dimensions of the known probability distribution 230 may be different than (e.g., smaller) the number of parameters of the dynamic model layer 214, and may be a size that enables effective learning of the contours of the distribution of dynamic model parameter sets. The known probability distribution 230 may be any suitable probability distribution, such as a Gaussian (e.g., having a Standard Distribution) or other suitable distribution from which samples may be drawn.

The trained invertible model 240 learns parameters for defining an invertible function between a sampled point in the known probability distribution 230 and points in an output space corresponding to the set of dynamic parameters in the dynamic model layer 214 and value ranges of the dynamic parameters. That is, the learned invertible function of the trained invertible model 240 provides for a bijective correspondence between the space of the known probability distribution and a space of the dynamic model parameter sets. As the learned function is invertible, values in each space have a 1:1 correspondence, such that individual values in the known probability distribution 230 map to individual points in the space of dynamic model parameter sets. Similarly, a particular dynamic model parameter set can map to an individual point in the known probability distribution (i.e., the points are invertible back through the invertible model). The architecture of the trained invertible model 240 may differ in various embodiments and generally provides parameters for learning an invertible function between the spaces of the known probability distribution and the parameters of the dynamic model layer 214. In particular, the trained invertible model 240 typically permits a feedforward transformation of sampled points in the probability distribution to the dynamic model parameter space and a backpropagation of an objective function to modify parameters of the trained invertible model 240 (e.g., such that points in the probability distribution may be recovered from dynamic model parameter sets). In various embodiments, the architecture of the invertible model is a normalizing flow or other suitable generative model, although additional model types for modeling an invertible function may also be used. The trained invertible model 240 may have any suitable number of model layers with various types of layer transformations that convert points between the respective input/output spaces.

Thus, a particular sampled point in the probability distribution 230 corresponds to a unique dynamic model parameter set. That is, the output of the trained invertible model generates a complete “set” of dynamic model parameter values simultaneously for the dynamic model layer 214 based on the sample in the known probability distribution 230. In the example of FIG. 2, the output of the trained invertible model 240 may thus generate a particular set of values for dynamic parameters Θ₁₋₄ as a “point” in the output space of the dynamic model parameters. As such, in contrast to architectures that model each individual parameter of a model as a Bayesian distribution (e.g., in Bayesian Neural Networks), this architecture samples from the known probability distribution 230 and, from that sample, generates a corresponding combination of dynamic parameter values (i.e., a single sample of the known probability distribution is processed to generate multiple (or all) dynamic parameter values together). As such, the trained invertible model 240 may learn more complex inter-relationships between dynamic model parameter values that is not possible when individual parameters are individually modeled as separate distributions. Rather than learning individual parameters disjointly, this approach enables more effective learning of nuanced contours of dynamic parameter values in the distribution of dynamic model parameter sets. For example, the invertible model 240 enables learning relationships between dynamic parameter values, such as how an increase in one dynamic parameter value may likely increase (or decrease) another dynamic parameter while maintaining effective modeling predictions, which is not possible when individual parameters are modeled separately. By using different dynamic model parameter sets sampled through the trained invertible model 240, different instances of the uncertainty model can be used for uncertainty quantification of the model.

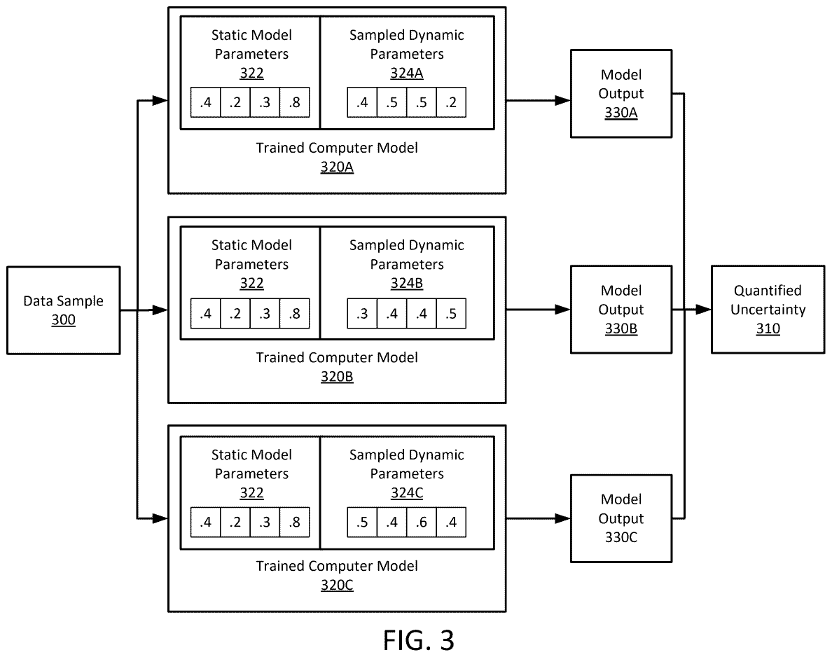

FIG. 3 shows an example evaluation of uncertainty quantification with respect to a data sample using an uncertainty model according to one or more embodiments. For a particular data sample 300, a quantified uncertainty 310 may be calculated that represents the potential variation in how the data sample 300 is evaluated by different trained models. To do so with the uncertainty model discussed above, particular “instances” of the model are determined that instantiate particular values for the dynamic parameters for the dynamic layer. As such, a set of trained computer models 320A-C are determined by using a set of static model parameters 322 in combination with respective sampled dynamic parameters 324A-C. As discussed above, for the static model parameters 322, each trained computer model 320A-C uses the same values of the static parameters. When the static model parameters 322 are applied in an earlier layer relative to the dynamic parameters 324, the static model parameters 322 may also be considered to represent a joint “backbone” of processing layers that may be performed for the data sample 300 irrespective of the particular sampled dynamic parameters 324.

To determine the sampled dynamic parameters 324A-C for each trained computer model 320A-C, a sample may be obtained from a probability distribution and processed by a trained invertible model to obtain each respective set of sampled dynamic parameters 324. In the example of FIG. 3, a first sample of the probability distribution is transformed by the invertible model to obtain sampled dynamic parameters 324A, a second sample of the probability distribution is transformed by the invertible model to obtain sampled dynamic parameters 324B, and a third sample of the probability distribution is transformed by the invertible model to obtain sampled dynamic parameters 324C. Though three trained computer models 320A-C are shown in FIG. 3 with respective sampled dynamic parameters 324A-C, various embodiments may include additional or fewer computer models obtained by transforming probability distribution samples to a set of dynamic parameters.

The data sample 300 is then processed by each “instance” of the trained computer model 320 with the respective sampled dynamic parameters 324. In the example of FIG. 3, the data sample 300 is processed by the trained computer model 320A using static model parameters 322 and sampled dynamic parameters 324A to generate model output 330A; the data sample is also processed by the trained computer model 320B using static model parameters 322 and sampled dynamic parameters 324B to generate model output 330B; and the data sample is also processed by the trained computer model 320C using static model parameters 322 and sampled dynamic parameters 324C to generate model output 330C. Although shown here as separately processing pipelines, in some embodiments the processing for the trained computer models 320A-C may be consolidated or deduplicated when identical processes or parameter values are applied by multiple models. For example, the static model parameters 322 are identical across the instances of the trained computer model 320A-C, such that the static model parameters may be applied to the data sample 300 to obtain a data sample representation that may then be distributed for processing by the separate sampled dynamic parameters 324A-C.

The model outputs 330A-C may then be evaluated with respect to one another to determine a quantified uncertainty 310 for the output of the uncertainty model with respect to the data sample 300. The quantified uncertainty 310 may be, for example, determined based on relative similarity or difference between the model outputs 330. For example, the quantified uncertainty 310 may be determined as a statistical variance or deviation of the model outputs 330 or another statistical measure of the differences between the different model outputs 330A-C.

In this sense, each set of sampled dynamic parameters 324 “instantiates” a different configuration of a trained computer model 320. Because the invertible model outputs a set of dynamic parameters together, the invertible model can effectively model the distribution of dynamic model parameters that represent different “effective” values of the dynamic parameters (according to the training data). That is, because the sampled dynamic parameter values represent different dynamic parameter values learned based on the training set, the model outputs 330A-C, based on the different sampled dynamic parameters, represent different model predictions that could be obtained by different learned values of the dynamic parameters. When the model outputs 330A-C are relatively similar or have relatively low differences with one another (and a correspondingly low quantified uncertainty 310), this indicates that different dynamic model parameter sets yield similar predictions for the data sample 300. Similarly, when the model outputs 330A-C are relatively dissimilar or have relatively high differences with one another (and a correspondingly high quantified uncertainty 310), it suggests that different dynamic model parameter sets yield results in different predictions for the data sample 300. As such, the quantified uncertainty 310 can indicate an extent to which the model outputs 330 (for this data sample) may be affected by the particular portion of the dynamic parameter distribution used for a particular instance of the computer model.

As discussed below, the quantified uncertainty 310 for the data sample 300 may then be used for various applications, such as determining whether to automatically apply an action to the data sample 300. As one application, quantified uncertainty may be used to determine whether the data sample 300 is considered in-distribution or out-of-distribution with respect to a training data set. Evaluation of data samples that are “in-distribution” with respect to members of the training data set may be expected to perform relatively similarly across the distribution of dynamic model parameters. However, for a data sample that is “out-of-distribution” with respect to the training data set, the data sample is expected to have characteristics that differ meaningfully from the distribution of the training data set, such that models trained on the training data set are expected to perform unpredictably on data that differs from its training data. This unpredictability can be captured when model outputs 330A-C significantly differ for the same data sample 300 as different portions of the trained distribution of dynamic model parameters interpret the data sample 300 meaningfully differently. As such, a quantified uncertainty 310 may be used to identify data samples that are out-of-distribution with respect to a training data set when the quantified uncertainty 310 exceeds a threshold value.

To determine the threshold value for detecting that a data sample is out-of-distribution, the threshold value may be determined based on the training data set. The threshold value may be specified in any suitable manner. In one embodiment, the data samples in the training data set may be evaluated to determine the quantified uncertainty 310 for the data samples of the training data set. The threshold value for detecting that a data sample is out-of-distribution may then be set to a specified quantile of the quantified uncertainty associated with the training data, such as the 90^{th}, 95^{th}, 98^{th}, or 99^{th} quantile of the training data quantified uncertainty values. As another example, additional or alternate statistical measures of the quantified uncertainty for the training data may be used to determine the threshold, such as a mean and deviation of the quantified uncertainty, to determine a value for the quantified uncertainty that would be sufficiently unlikely within the training data set.

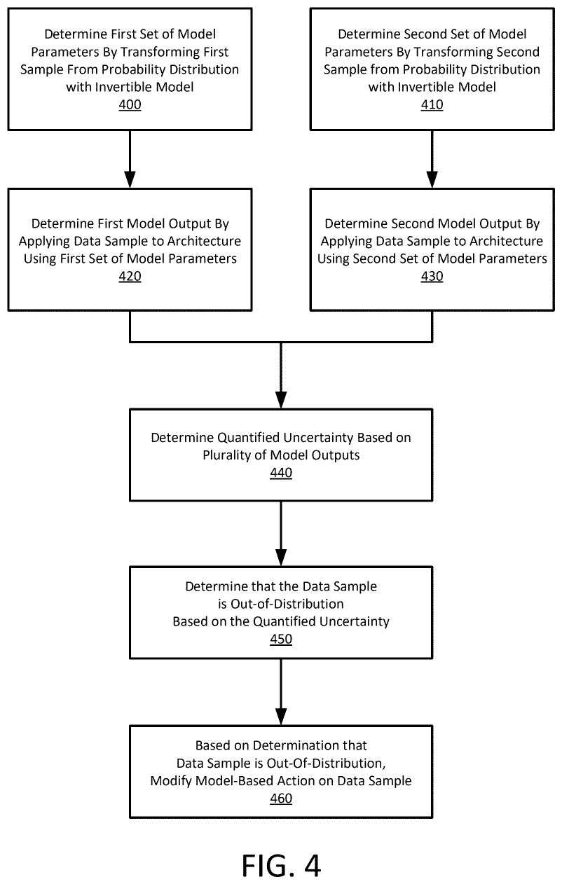

FIG. 4 is an example flowchart for applying an uncertainty model with dynamic model parameters for uncertainty quantification, according to one embodiment. This process may be performed, for example, by a module of the uncertainty modeling system 100, such as an inference module 110. Initially, the process may have access to a trained uncertainty model, such as an uncertainty model 140, in which parameters for one or more layers of the model are dynamically determined by sampling from a distribution and transforming the samples via an invertible model as discussed above. A plurality of model instances are determined by determining a dynamic model parameter for each instance from the distribution of dynamic model parameters. For example, for a first instance of the model architecture, a first set of model parameters is determined 400 by transforming a first sample from a probability distribution with an invertible model. Similarly, for a second instance of the model architecture, a second set of model parameters is determined 410 by transforming a second sample from the probability distribution with the invertible model. As discussed above, samples from the probability distribution may be transformed to particular values of the dynamic parameters for each of the model instances. In some circumstances, a number of “instances” of the model architecture may already be determined, such that a plurality of dynamic model parameters were previously sampled from the distribution of dynamic model parameters.

For each of the plurality of model instances (i.e., each having a particular set of dynamic model parameter values), the data sample is applied to the model instance to determine respective model outputs. In the example of FIG. 4, the data sample is applied to the model architecture using the first set of model parameters to determine the first model output 420 and the data sample is applied to the model architecture using the second set of model parameters to determine 430 the second model output. As also discussed above and with respect to FIG. 3, multiple model outputs may be generated based on respective values for the dynamic model parameters. Using the plurality of model outputs from the plurality of model outputs, a quantified uncertainty is determined 440 as discussed above and may include applying one or more statistical measures to the plurality of model outputs.

The quantified uncertainty of the data sample may then be used for various purposes, such as determining 450 that a data sample is out-of-distribution. As discussed above, the quantified uncertainty may be compared with a threshold to determine whether the data sample belongs to the distribution of the training data used to train the uncertainty model. Using the determination of whether a data sample is in- or out-of-distribution may then be used to affect further actions related to the data sample. For example, when the data sample is determined to be in-distribution, that may indicate that models trained on that training data may be reliably applied to the current data sample, as the characteristics of the data sample are similar to those of the previous data learned by the model. Similarly, when the data sample is out-of-distribution with respect to the training data set for a model, application of that model may be unpredictable as the model's output (e.g., a classification) may have a poor basis for any prediction because it did not train on similar data.

In many instances, the data sample may be applied to a model (which may differ from the uncertainty model) trained on the same training data as the uncertainty model. The output of this model may be used to determine an action to perform based on the trained model. For example, a model may be used for data sample classification and processing, image models may be used to detect and classify objects, sensing models may detect the location of objects in a region around a sensor, and so forth. When the data sample is determined as in-distribution, outputs from these models may continue to be processed to automatically determine actions for the data sample. When the data sample is determined 450 as out-of-distribution, processing of the data sample may be modified to reflect the reduced reliability of the trained model. As one example, a model-based action may be modified 460 based on the determination that the data sample is out-of-distribution. That is, the determination that the data sample is out-of-distribution based on the uncertainty model (e.g., as discussed for FIGS. 3 & 4) may be used to affect actions related to another trained model. Actions that may otherwise be indicated by application of the other model may be prevented from automatic application, and the uncertainty reflected in the data sample being out-of-distribution may be used to modify a processing pipeline for the data sample, such as taking an alternate action for the data sample.

As one example, in robotics or automated vehicle applications, objects in an environment may be detected by processing images from one or more imaging sensors and used to automatically plan and execute behaviors in the environment. Data samples received by image sensors may be processed by the uncertainty model to determine whether the data samples belong to the distribution of the training data used to train these perception and planning models. When the data samples are determined as in-distribution, the object detection and planning may proceed normally. However, when the data sample is determined as out-of-distribution, various actions may be modified to account for the increased unreliability of the models when applied to out-of-distribution data. For example, the particular type of detected object and its addition to an environmental model may be affected, or motor planning and motor behaviors may be affected to capture the increased uncertainty about object detection in the environment, for example to reduce speed, explore the environment in smaller increments, or otherwise increase safety margins.

As another example embodiment, automated models may be used to automatically evaluate health or financial information, such that data samples may be evaluated and one or more actions taken or labels applied when the data sample is in-distribution. When the data sample is determined 450 to be out-of-distribution, these automated actions may be modified 460 or prevented, for example such that the data sample is instead processed by alternative models, processes, or by human evaluation due to the increased uncertainty of applying a model to the data sample determined to be out-of-distribution.

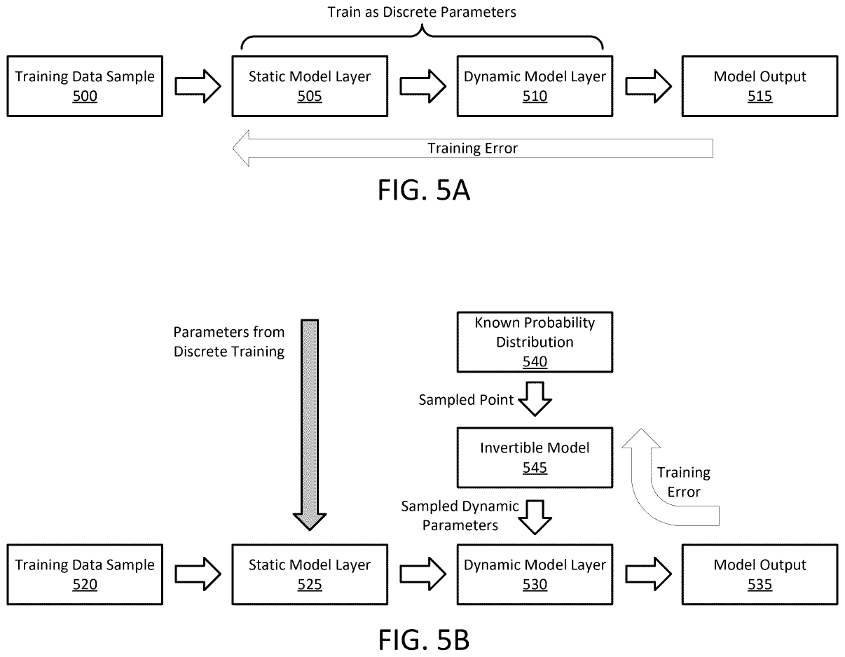

FIGS. 5A-B show an example data flow for training an uncertainty model, according to one embodiment. This process may be performed, for example, by a training module 120 as shown in FIG. 1. When the uncertainty model architecture includes a static model layer and a dynamic model layer as discussed above, it may be computationally difficult and, in some cases, intractable to directly attempt to learn parameters of the static model layer (occurring earlier in the model architecture but “later” in backpropagating a training objective) as well as the invertible model. To improve training for the uncertainty model, in some embodiments, the uncertainty model parameters may be trained in two steps. In a first step, shown in FIG. 5A, the static model parameters may be trained while learning discrete values for parameters of the dynamic model parameters (i.e., instead of a distribution of dynamic parameter values). In a second step, shown in FIG. 5B, the trained parameter values of the static model layer are fixed based on the learned values of the first step and the distribution of dynamic parameter values is learned by training parameters of the invertible model.

In this example embodiment, during the first training phase shown in FIG. 5A, the model architecture treats a dynamic model layer 510 (as well as a static model layer 505) as having discrete model parameter values, rather than as a sample from a distribution. That is, during the first training phase, the model architecture may learn a particular set of model parameters for the dynamic model layer 510, rather than a distribution. To do so, a training data sample 500 (or a plurality of training data samples 500 as part of a training batch) is processed by parameters of the static model layer 505 and dynamic model layer 510 to generate a respective model output 515. The particular model training method may vary in different embodiments. As one example, the model output 515 may be compared with a label for the training data sample 500 to determine a training error for the current values of the model parameters.

The training process may then modify parameters of the model, including parameters of the dynamic model layer 510 and static model layer 505 to reduce the training error of the model output 515 given the training data sample 500 as an input. In other examples, the training process may modify parameters to maximize a training objective rather than minimize a training error (or alternatively, a training loss). The parameters of the model may be modified according to any suitable model training method according to the particular data type and model architecture used in the particular embodiment. The model parameter training method may include backpropagating an error through layers of the model architecture and may include, e.g., steps of a gradient descent algorithm to modify the model parameters. The training process may include processing a plurality of training batches from a training data set to modify parameters of the model until a stopping condition, such as processing a complete set of training data samples, reaching local parameter optimization, model parameter updates are below a threshold, and so forth. As one additional example, during the first training step of FIG. 5A, the model parameters (including the static model layer 505 and dynamic model layer 510) may be trained with maximum likelihood training processes with respect to the training data, labels, and respective model outputs. In particular, the training process in one embodiment aims to maximize the log probability log p(D|θ_{S}, θ_{Dy}) of the training data D for static model layer 505 parameters es and dynamic model layer 510 parameters θ_{Dy}. By training the static model layer 505 in this way, the distribution of dynamic layer parameters may then be learned in a second step while holding parameters of the static model layer 505 constant. Though particular values for parameters θ_{Dy} of the dynamic model layer 510 are learned in the process shown in FIG. 5A, the second step may use the learned values of the static model layer 505 to enable learning a distribution of dynamic parameter sets for the dynamic model layer 510 via parameters of an invertible model.

As shown in FIG. 5B, the learned values of the static model layer 505 during the first training step may then be set as fixed values of a static model layer 525. Training data samples 520 are processed by the static model layer 525 and then through a set of sampled dynamic parameters of a dynamic model layer 530 to generate a respective model output 535. The set of parameters for the dynamic model layer 530 are sampled from the distribution defined by the parameters of an invertible model 545 that transforms sampled points from a known probability distribution 540 as discussed above. That is, particular instances of the dynamic model layer 530 are generated by sampling from the known probability distribution 540, then processing the sampled point through the invertible model 545 to generate a set of sampled dynamic parameters for the dynamic model layer 530. In some embodiments, multiple points may be sampled from the known probability distribution 540 to generate multiple sampled dynamic parameter sets applied to the same training data sample 520, such that multiple regions of the distribution of dynamic parameter sets may be evaluated for the same training data sample 520. Though one training data sample 520 is shown here, training may be processed in one or more batches that process a plurality of training data samples 520 together and modify the distribution (i.e., parameters of the invertible model 545) based on an error for the training batch. The set of training data samples used to learn the distribution of dynamic model parameters may differ from the training data used to train the static model layer parameters discussed with respect to FIG. 5A or may be a different training data set.

The model output 535 can be evaluated with respect to a training error/objective/cost function as discussed above, such as a label associated with the training data sample 520. The training error may then be evaluated with respect to the sampled dynamic parameters (or the distribution of dynamic model parameters), such that the training error may then be applied to train parameters of the invertible model 545. In one embodiment, the distribution of dynamic parameters may be learned by modifying parameters of the invertible model 545 to maximize an expectation of the data sample labels based on the sampled parameter sets from the distribution (i.e., according to the known probability distribution 540 as transformed by the invertible model 545). Particularly, the expectation 1E of the log probability may be maximized for training data samples D according to:

$${𝔼}_{{θ}_{D y} ∼ {q}_{η}} [ log p ( D \vert {θ}_{s}^{*} , {θ}_{D y} ) ] ,$$

where dynamic model parameters θ_{Dy} are sampled from the dynamic parameter distribution q_{η} according to the invertible model 545, and static model parameters

$${θ}_{s}^{*}$$

are then fixed during training (and may be determined based on an earlier training step as shown in FIG. 5A). In one example embodiment, the dynamic parameter distribution q_{η} is learned by training parameters of the invertible model 545 to maximize a standard evidence lower bound (ELBO) of the training data set using variational inference (VI).

By training the dynamic model layer 530 using fixed values of the static model layer 525, the distribution of dynamic model parameters may be tractably learned for later model layers (i.e., here, as a last model layer) without propagating training error/objective backward from the dynamic parameter distribution to earlier static model layers.

Though shown here as two separate training processes that may be applied to a model architecture by one training process, in additional embodiments, the process of FIG. 5B may be applied to pre-trained model architectures. That is, a pre-trained (or previously-trained) model architecture may have an existing sequence of model layers that include various parameters learned as discrete parameter values similar to the model training shown above with respect to FIG. 5A. In one embodiment, the process for learning a distribution of dynamic model parameters may be applied to an existing model architecture to convert the existing model architecture from a model applied to discrete parameter values to an uncertainty model that models one or more layers as dynamic model layers having parameters that may be sampled from a distribution. To do so, the trained model may be treated as having been generated, e.g., according to the “first step” shown in FIG. 5A. Then, a model layer (e.g., the last layer) may be selected as a dynamic model layer and have the learned parameters discarded, such that the selected layer's parameter values are instead determined by sampling from a probability distribution and processed by an invertible model 545. As such, the training process learns parameters of an invertible model 545 that define a distribution of dynamic model parameters as discussed with respect to FIG. 5B. Samples of the dynamic model parameters may then be obtained and used to evaluate a data sample to determine a quantified uncertainty for the model as discussed above (e.g., in FIGS. 3 and 4).

As such, the model training of FIGS. 5A-B enables training parameters for an uncertainty model for an architecture by initially learning discrete parameter values for a plurality of layers (e.g., a first layer corresponding to a static model layer of the uncertainty model and a second layer corresponding to a dynamic model layer), the model architecture using a first training set (e.g., to reduce an error associated with batches from the first training set). Then, the training process may fix the values of the static model layers (e.g., a first layer) and learn a distribution for the dynamic model layer by learning parameters of an invertible model from which samples are generated for the dynamic model layer. When training the invertible model, a batch of training data may be applied to the model architecture with dynamic parameter values using samples from the dynamic parameter distribution as generated by the invertible model from samples of a probability distribution. The training error, with respect to the sampled dynamic model parameter sets and training batch, may then be applied to train parameters of the invertible model and learn the distribution of dynamic parameter sets for the dynamic model layer.

Accordingly, this approach can place probability mass of the distribution of dynamic parameter values around “good” values (effective for predicting the training data labels). In addition, because the distribution of dynamic parameter values is determined with an invertible model (e.g., a normalizing flow), dynamic parameter values are prevented from collapsing to singular values. In addition, the output of dynamic parameters as a “set” from the invertible model allows modeling more complex contours of the distribution of dynamic model parameters that would not be possible if the dynamic parameters were independently learned.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system for training parameters of a model architecture including a static model layer and a dynamic model layer, comprising:
one or more processors; and
one or more non-transitory computer-readable media containing instructions executable by the one or more processors for:
applying a first training batch of training data samples to a model architecture having a first model layer followed by a second model layer;
training parameters of the first model layer and the second model layer to reduce a first training error associated with the first training batch;
applying a second training batch of training data samples to the model architecture having a static model layer with fixed parameters based on trained parameters of the first model layer and a dynamic model layer having dynamic parameters determined based on samples from a probability distribution applied to an invertible model; and
training parameters of the invertible model to learn a distribution of dynamic parameter sets for the dynamic model layer to reduce a second training error associated with the second training batch.

2. The system of claim 1, wherein the invertible model is a normalizing flow.

3. The system of claim 1, wherein training parameters of the invertible model comprises an expectation maximization of a standard evidence lower bound using variational inference.

4. The system of claim 1, wherein training parameters of the first model layer and the second model layer comprises training parameters to maximize the likelihood of labels associated with the first training batch.

5. The system of claim 1, wherein the instructions are further executable for:
determining an uncertainty quantification for a data sample with respect to the model architecture based on the distribution of dynamic parameter sets.

6. The system of claim 1, wherein the dynamic model layer is a last layer of the model architecture.

7. The system of claim 1, wherein trained parameters for the second model layer are not used when training parameters for the invertible model to learn the distribution of dynamic parameter sets.

8. A method for training parameters of a model architecture including a static model layer and a dynamic model layer, comprising:
applying a first training batch of training data samples to a model architecture having a first model layer followed by a second model layer;
training parameters of the first model layer and the second model layer to reduce a first training error associated with the first training batch;
applying a second training batch of training data samples to the model architecture having a static model layer with fixed parameters based on trained parameters of the first model layer and a dynamic model layer having dynamic parameters determined based on samples from a probability distribution applied to an invertible model; and
training parameters of the invertible model to learn a distribution of dynamic parameter sets for the dynamic model layer to reduce a second training error associated with the second training batch.

9. The method of claim 8, wherein the invertible model is a normalizing flow.

10. The method of claim 8, wherein the method for training parameters of the invertible model comprises an expectation maximization of a standard evidence lower bound using variational inference.

11. The method of claim 8, wherein the method for training parameters of the first model layer and the second model layer comprises training parameters to maximize the likelihood of labels associated with the first training batch.

12. The method of claim 8, wherein the method further comprises:
determining an uncertainty quantification for a data sample with respect to the model architecture based on the distribution of dynamic parameter sets.

13. The method of claim 8, wherein the dynamic model layer is a last layer of the model architecture.

14. The method of claim 8, wherein trained parameters for the second model layer are not used when training parameters for the invertible model to learn the distribution of dynamic parameter sets.

15. A non-transitory computer-readable media for training parameters of a model architecture including a static model layer and a dynamic model layer, the non-transitory computer-readable media containing instructions executable by a processor for:
applying a first training batch of training data samples to a model architecture having a first model layer followed by a second model layer;
training parameters of the first model layer and the second model layer to reduce a first training error associated with the first training batch;
applying a second training batch of training data samples to the model architecture having a static model layer with fixed parameters based on trained parameters of the first model layer and a dynamic model layer having dynamic parameters determined based on samples from a probability distribution applied to an invertible model; and
training parameters of the invertible model to learn a distribution of dynamic parameter sets for the dynamic model layer to reduce a second training error associated with the second training batch.

16. The non-transitory computer-readable media of claim 15, wherein the invertible model is a normalizing flow.

17. The non-transitory computer-readable media of claim 15, wherein the instructions for training parameters of the invertible model comprises an expectation maximization of a standard evidence lower bound using variational inference.

18. The non-transitory computer-readable media of claim 15, wherein the instructions for training parameters of the first model layer and the second model layer comprises training parameters to maximize the likelihood of labels associated with the first training batch.

19. The non-transitory computer-readable media of claim 15, wherein the instructions are further executable for:
determining an uncertainty quantification for a data sample with respect to the model architecture based on the distribution of dynamic parameter sets.

20. The non-transitory computer-readable media of claim 15, wherein the dynamic model layer is a last layer of the model architecture.
